(19) United States
(12) Patent Application Publication
(10) Pub. No.: US 2009/0253834 A1
(43) Pub. Date: Oct. 8, 2009

(54) ADHESIVE COMPOSITIONS USEFUL IN FLEXIBLE CIRCUIT SUBSTRATE APPLICATIONS AND METHODS RELATING THERETO

(75) Inventors: TAKASHI KINO, Tochigi (JP); Tsutomu Mutoh, Tochigi (JP)

Correspondence Address: E I DU PONT DE NEMOURS AND COMPANY;LEGAL PATENT RECORDS CENTER, BARLEY MILL PLAZA 25/1122B, 4417 LANCASTER PIKE, WILMINGTON, DE, 19805, US

(73) Assignee: E. I. DU PONT DE NEMOURS AND COMPANY, Wilmington, DE (US)

(21) Appl. No.: 12/268,723

(22) Filed: Nov. 11, 2008

Related U.S. Application Data
(60) Provisional application No. 61/043,148, filed on Apr. 8, 2008.

(51) Int. Cl. C09J 123/02; C08L 29/02; C08K 5/5373; C09J 161/06; C08K 5/56

(52) U.S. Cl. 524/100; 525/133; 525/132; 524/130; 524/508

(57) ABSTRACT

This invention is directed to an adhesive composition having (1) a elastomer component, (2) a resole phenolic resin, and (3) a flame retardant resin that is not (2) a resole phenolic resin. Further, the adhesive compositions of the invention includes (1) a elastomer component and (2) a resole phenolic resin, wherein the (2) resole phenolic resin content is 20 to 50 wt % based on the total amount of the adhesive composition excluding any solvent.

### FIELD OF DISCLOSURE

The present invention relates generally to adhesive compositions useful in flexible circuit substrate applications, e.g., as an adhesion component of a cover lay film. More particularly, the adhesive compositions of the present invention are flame resistant and halogen-free.

### BACKGROUND OF DISCLOSURE

Enormous progress has been made in the recent development of flexible printed circuits (FPC) in view of the increasing demand for smaller electronic devices with a greater degree of design freedom. FPC development for cell phones has been particularly active. Substrates upon which circuits have been formed are often protected by insulating films to protect the circuitry. The insulating film and substrate are typically bonded by a flame retardant adhesive. The insulating films are generally laminated in such a way that the adhesive layer and circuitry are not in contact.

An example of an adhesive used in FPC is the acrylic adhesive disclosed in Japanese Laid-Open Patent Application No. 2005-139391, which is composed of an acrylic adhesive composition containing (A) 100 mass parts acrylic polymer that has epoxy groups and a glass transition temperature of 5 to 30° C., (B) 1 to 20 mass parts resole phenolic resin, and (C) 0.1 to 3 mass parts accelerator. Epoxy adhesives employing epoxy resins are also widely used.

Advantages of epoxy adhesives are that cross linking density is relatively easy to control, and epoxy adhesives are suitable for diverse requirements, including halogen-free flame retardance. However, epoxy tends to have storage stability problems, oftentimes necessitating cold storage or other precautions.

Acrylic adhesives, on the other hand, are known to have sufficient storage stability in comparison to epoxy systems and to have stable adhesive strength for a wide range of substrates. However, acrylic adhesives are generally flammable. The introduction of halogen atoms is a widely known technique for improving flame retardance. However, there is increasing demand for halogen-free adhesives out of concern for the environment.

The addition of flame retardant filler is another technique for improving flame retardance. However conventional acrylic adhesives require the addition of an undesireably large amount of flame retardant filler to achieve the necessary level of flame retardancy. The addition of large amounts of filler can be expensive and tends to cause a loss of film adhesion, flexibility, and strength.

An example of a technique related to halogen-free acrylic adhesives used in FPC is the adhesive composition for semiconductor devices in Japanese Laid-Open Patent Application No. 2002-88338, which is a thermosetting type of adhesive comprising at least one each of (A) thermoplastic resin, (B) thermosetting resin, and (C) phosphorus-based flame retardant, characterized by further comprising (D) magnesium hydroxide. Japanese Laid-Open Patent Application No. 2003-119392 also discloses a flame retardant resin composition in which (A) a phosphorus-based flame retardant and (B) a nitrogen-based flame retardant are essential components, characterized in that the phosphorus content of the resin composition is X wt % and the nitrogen content is Y wt %, where X and Y are such that 7≦2X+Y≦16, and 2≦X≦5, and Y≧1.

### SUMMARY

The present invention is direct to halogen-free, flame retardant adhesive compositions and is also directed to cover lay films employing such adhesive compositions. The adhesive compositions of the present disclosure comprise about: i. 12-48 weight parts of an elastomer component; ii. 2-55 weight parts of a resole phenolic resin; and iii. 20-70 weight parts of a flame retardant aromatic resin.

### DETAILED DESCRIPTION OF THE PREFERRED EMBODIMENT(S)

The inventors have discovered that elastomer based resole phenolic adhesives can have improved flame retardancy while also maintaining desired adhesive properties (for electronics applications) by decreasing the proportional amount of elastomer component, and:
i. adding an adhesive aromatic resin other than a resole phenolic resin; and/or
ii. ii. increasing the proportion of the resole phenolic resin.
   The inventors have also surprisingly discovered that such formulations can be loaded with relatively low amounts of flame retardant filler, while nevertheless achieving excellent flame retardancy while also maintaining desired adhesive properties.

In one embodiment, the adhesive compositions of the present disclosure comprise: (1) an elastomer component, and (2) an aromatic resin comprising: i. a resole phenolic, and ii. a flame retardant aromatic resin that is other than a resole phenolic resin. “Flame retardant aromatic resin” is intended to mean a resin comprising at least 50 weight percent aromatic polymer, whereby the resin is able to pass a simplified version of UL 94 (hereafter referred to as “UL 94-SV” or sometimes “UL 94-SV Flamability Test”). The UL 94-SV Flammability Test procedure is as follows:
1. dissolve the resin in a solvent,
2. cast the solution on a polyimide film whose thickness is 25 microns,
3. volatize away the solvent completely,
4. cut the resulting specimen into a 20 cm×5 cm sample,
5. bend the specimen into a the cylinder structure in the longitudinal axis direction with a 13 mm diameter and with the polyimide film facing outside,
6. staple one end of the cylinder to maintain the structure,
7. burn the specimen from the edge with a flame for 3 seconds, and
8. measure whether the specimen burned to the other edge (if the other edge of the specimen is burned, then the flammability test result is a failure; otherwise the specimen passes).
   A “flame retardant aromatic resin” is intended to mean any aromatic resin that passes the UL 94-SV Flammability Test The adhesive compositions of the invention can be used to produce a cover lay film. When adapted to a cover lay film, the adhesive composition is in the form of a sheet, but the concept of the “adhesive composition” in the invention encompasses not just the form of a sheet but also the liquid before it is formed into a sheet. The structural elements of the adhesive composition are described below.

(1) Elastomer Component

In the present invention, the elastomer component is added to provide flexibility. The elastomer component generally also contributes to better adhesion. The elastomer component refers to components having elasticity produced by molecular chain entanglement. Depending on the temperature, polymers can be in the form of solids (<T_{g}), glass (T_{g}<<Tₘ), or liquids (Tₘ<). Elastomer components of the present invention are generally glassy at room temperature (25° C.). In some embodiments, the elastomer component is: i. an acrylic polymer, ii. a butadiene based elastomer, iii. a polyamide, iv. polyester or v. a mixture of any of i. through iv. In some embodiments, the elastomer component is: i. an acid component-containing ethylene/acrylic copolymer, ii. an acid component-containing acrylic elastomer, iii. an acid component-containing butadiene based elastomer, or iv. a mixture of any of i. iii. The inclusion of these as elastomer components will generally improve adhesiveness and flexibility.

In some embodiments, the acid components include carboxyl groups, sulfate groups, phosphate groups, and phenolic hydroxyl groups. In some embodiments, carboxyl groups are preferred, due to improved stability. The acid component may be introduced by acid treatment of the elastomer component terminals or by the combined use of acid component-containing compounds in the form of monomers.

In some embodiments, ethylene/acrylic copolymers are selected from a group consisting of ethylene-alkyl acrylate-glycidyl acrylate copolymers, ethylene-methacrylic acid copolymers, ethylene-ethyl methacrylate-acrylic acid copolymers, ethylene-acrylic acid-butyl acrylate copolymers, ethylene-methyl acrylate-maleic acid monoester copolymers, ethylene-methyl acrylate-acrylonitrile copolymers, ethylene-ethyl methacrylate-styrene copolymers and mixtures thereof. Commercially available products include Bond Fast™ 7M (Sumitomo Chemical), Elvaloy® 4051, Vamac® G, and Vamac® GLS (all by Mitsui Du Pont Polychemical). In some embodiments, the ethylene/acrylic copolymers are used in mixtures of two or more ethylene/acrylic copolymers.

Acrylic elastomers are polymers based on acrylic acid esters and/or methacrylic acid esters. They may be prepared by any of solution polymerization, emulsion polymerization, suspension polymerization, or bulk polymerization. The acrylic acid esters and/or methacrylic acid esters will endow the acrylic adhesive composition with flexibility. In some embodiments, acrylic acid esters are selected from a group consisting of methyl acrylate, ethyl acrylate, n-butyl acrylate, isobutyl acrylate, isopentyl acrylate, n-hexyl acrylate, isooctyl acrylate, 2-ethylhexyl acrylate, n-octyl acrylate, isononyl acrylate, n-decyl acrylate, isodecyl acrylate and mixtures thereof. In some embodiments, methacrylic acid esters are selected from a group consisting of methyl methacrylate, ethyl methacrylate, n-butyl methacrylate, isobutyl methacrylate, isopentyl methacrylate, n-hexyl methacrylate, isooctyl methacrylate, 2-ethylhexyl methacrylate, n-octyl methacrylate, isononyl methacrylate, n-decyl methacrylate, isodecyl methacrylate and mixtures thereof. In some embodiments, butadiene elastomer include acrylonitrile-butadiene copolymer elastomer obtained by the copolymerization of acrylonitrile and butadiene. In some embodiments, the terminals may be carboxylated to introduce an acid component. The acid component may also be introduced by ternary copolymerization of a carboxyl group-containing polymerizable monomer such as acrylic acid along with the acrylonitrile and butadiene. In some embodiments, butadiene based elastomers include Nipol™ 1072 and Nipol™ 1072J (both by Nippon Zeon), Krynac™ X7.5 (Bayer), Hycar CTBN1300XB, CTBN1300X15, and CTBNX1300XB (all by BF Goodrich Chemical), and PHR-1H (by JSR). In some embodiments, butadiene based elastomers are used in mixtures of two or more.

In some embodiments, the elastomer component is blended in an amount between (and optionally including) any two of the following: 12, 15, 20, 25, 30, 35, 40, 45, 50, 55 to 60 wt %. In other embodiments, the elastomer component is blended in an amount between (and optionally including) any two of the following: 15, 20, 25, 30, 35, 40, 45 and 48 wt %, based on the total amount of the adhesive composition minus any solvent.

In another embodiment, when the total amount of the elastomer component, resole phenolic resin, and flame retardant aromatic resin is used as the basis, the elastomer component is blended in an amount between (and optionally including) any two of the following: 40, 45, 50, 55, 60, 65, 70 and 75 wt %. In another embodiment, the elastomer component is blended in an amount between (and optionally including) any two of the following: 50, 55, and 60 wt %.

(2) Resole Phenolic Resin

In the present invention, the resole phenolic resin is blended to three dimensionally cross link the elastomer component and improve heat resistance. Resole phenolic resin is a resin having a three dimensional reticulated structure, and is generally synthesized using phenol and formaldehyde starting materials. The molecular weight, softening point, and OH equivalent of the resole phenolic resin are not particularly limited.

In some embodiments, the resole phenolic resin includes those prepared from starting materials selected from a group consisting of phenol, bisphenol A, p-t-butylphenol, octylphenol, p-cumylphenol and other such alkyl phenols, p-phenylphenol, and cresol.

Examples of commercially available resole phenolic resins include Nikanol™ (Fudow Corp.), Shonol™ (Showa High Polymer Co., Ltd.), Sumilite™ Resin(Sumitomo Bakelite), Phenolite™ (Danippon Ink), and BKS™ Resin (Georgia-Pacific Resin).

In some embodiments, the resole phenolic resin may be in the form of either a solid or liquid. In other embodiments, liquids are preferred from the standpoint of cross linking density.

In some embodiments, the resole phenolic resin is preferably blended in an amount between (and optionally including) any two of the following: 0.6, 1, 5, 10, 15, 20, 25, 30, 35, 40 and 44 wt %. In another embodiment, the resole phenolic resin is preferably blended in an amount between (and optionally including) any two of the following: 1.5, 2.5, 3.5, 4.5, 5, 5.5, 10, 10.5, 15, 15.5, 20, 20.5, 30, 30.5, and 40 wt %, based on the total amount of the adhesive composition minus any solvent. This range will ensure good adhesive properties.

In some embodiments, when the total amount of the elastomer component, resole phenolic resin, and flame retardant aromatic resin is used as the basis, the resole phenolic resin is preferably blended in an amount between (and optionally including) any two of the following: 2, 5, 10, 15, 20, 25, 30, 35, 40, 45, 50 to 55 wt %. This range will ensure good adhesive properties.

(3) A Flame Retardant Aromatic Resin That is Other Than a Resole Phenolic Resin

In the present invention, the flame retardant aromatic resin that is other than a resole phenolic resin, does not burn up to the other edge when it is burned according to the Flammability test. The Flammability test is a simplified version of UL 94 (referred herein to as UL 94-SV or UL 94-SV Flammability Test). The UL 94-SV Flammability Test procedure is as follows:
1. dissolve the resin in a solvent,
2. cast the solution on a polyimide film whose thickness is 25 microns,
3. volatize away the solvent completely,
4. cut the resulting specimen into a 20 cm×5 cm sample,
5. bend the specimen into a the cylinder structure in the longitudinal axis direction with a 13 mm diameter and with the polyimide film facing outside,
6. staple one end of the cylinder to maintain the structure,
7. burn the specimen from the edge with a flame for 3 seconds, and
8. measure whether the specimen burned to the other edge (if the other edge of the specimen is burned, then the flammability test result is a failure; otherwise the specimen passes).

The condition for the size of the flame and how to apply the flame is followed in the same way written in UL94, 11.5 Procedure of Thin Material Vertical Burning Test, VTM-0 (p.26). Specimens are to be preconditioned in accordance with ASTM D618 (ISO 291) at 23±2° C. and 50±5 percent relative humidity for a minimum of 48 hours. All specimens are to be tested in a laboratory atmosphere of 15-35 C and 45-75 percent relative humidity in the same way written in UL94 6 Conditioning (p. 9)

In the present invention, the flame retardant aromatic resin is blended to provide adhesion and flame retardance.

In some embodiments, the flame retardant aromatic resins are selected from a group consisting of aromatic polyesters such as polyethylene terephthalate (PET), polybutylene terephthalate (PBT), polytrimethylene terephthalate (PTT), and polyethylene naphthalate (PEN), aromatic urethane resins, aromatic polyamides (PA), polycarbonates (PC), polyarylene sulfide (PAS) resins, polyphenylene ethers (PPE), modified PPE, aromatic polyimides (PI), aromatic polyamidoimides (PAI), aromatic polyether imides (PEI), aromatic polysulfones (PSU), modified aromatic PSU, polyether sulfones (PES), aromatic polyketones (PK), aromatic polyether ketones (PEK), novolac phenolic resins, phenoxy resins, and epoxy resins. In some embodiments, the flame retardant aromatic resins may be used in mixtures of two or more. In other embodiments, novolac phenolic resins and xylene-modified phenolic resins are preferred flame retardant aromatic resins from the standpoint of compatibility with the elastomer component. Phenolic resins also generally have these properties, and a broad range of phenolic resins can be adopted in the present invention.

In some embodiments, the flame retardant aromatic resin is blended in an amount between (and optionally including) any two of the following: 6.9, 7.5, 8.5, 10.5, 12.5, 14.5, 16.5, 18.5, 20.5, 22.5, 24.5, 26.5, 28,5, 30.5, 32.5, 34.5, 36.5, 38.5, 40.5, 42.5, 44,5, and 47.4 wt %, based on the total amount of the adhesive composition minus any solvent.

When the total amount of the elastomer component, resole phenolic resin, and flame retardant aromatic resin is used as the basis, the elastomer component is preferably blended in an amount between (and optionally including) any two of the following: 40, 45, 50, 55, 60, 65 and 75 wt %. This range will generally ensure good adhesive properties.

In one embodiment of the invention, a resole phenolic resin and a flame retardant aromatic resin are combined, and the total content of the resole phenolic resin and flame retardant aromatic resin is preferably in a range between (and optionally including) any two of the following: 0.6, 1, 1.5, 5, 10, 15, 20, 25, 30, 35, 40 and 44 wt % based on the total amount of the adhesive composition minus any solvent. When the total amount of the elastomer component, resole phenolic resin, and flame retardant aromatic resin is used as the basis, the total content of the resole phenolic resin and flame retardant aromatic resin is preferably in a range between (and optionally including) any two of the following: 25, 30, 35, 40, 45, 50, 55 and 60 wt %. This range will generally ensure good adhesive properties.

(4) Flame Retardant Filler

In the present invention, a flame retardant filler can be blended to aid flame retardance, to stabilize the release stability (adhesive cohesion and release) and moisture absorption, and the like. Any flame retardant filler may be used but, from the standpoint of further enhancing flame retardance, is preferably added in a range that will not adversely affect the FPC properties. The flame retardance of the adhesives can be significantly increased with low amounts of flame retardant filler when the amount of the resole phenolic resin is increased or when a flame retardant aromatic resin is also added.

In some embodiments, the flame retardant filler may be an organic or inorganic component. In some embodiments, the flame retardant fillers are selected from a group consisting of phosphorus-based flame retardants melamine polyphosphate derivatives, aluminum phosphonate, nitrogen-based flame retardant melamine cyanurateand mixtures thereof. In another embodiment, from the stand point of flame retardant efficiency, melamine polyphosphate derivatives, aluminum phosphonate and mixtures are preferred.

In one embodiment, when using the phosphorus-based flame retardants aluminum phosphonate and melamine polyphosphate derivatives, the content in terms of phosphorus atoms is at least 3 wt % based on the total amount of the adhesive composition minus all solvents. In another embodiment, the content in terms of phosphorus atoms is not less than 4.5 wt % based on the total amount of the adhesive composition minus all solvents. In general, the greater the content, the greater the flame retardant effects. The flame retardance can therefore be increased with the addition of low amounts. The maximum content in terms of phosphorus atoms is not particularly limited, but in consideration of the effects on properties other than the flame retardance, the content is usually 5 wt % based on the total amount of the adhesive composition minus any solvent.

In some embodiments, inorganic fillers may be combined with the above flame retardant. In one embodiments, the inorganic fillers are selected from a group consisting of metal hydroxides such as aluminum hydroxide and magnesium hydroxide; metal carbonates such as calcium carbonate and magnesium carbonate; metal silicates such as calcium silicate; metal oxides such as calcium oxide, magnesium oxide, aluminum oxide (alumina), silicone oxide, and molybdenum oxide; metal nitrides such as aluminum nitride; borate compounds such as aluminum borate whiskers, zinc borate, and magnesium borate; and boron nitride and crystalline or amorphous silica. In some embodiments, the inorganic filler is used in combinations of two or more.

In some embodiments, the filler will have preferably undergone a hydrophobization treatment with a treatment agent such as a silane coupling agent or titanate coupling agent to improve water resistance and inorganic filler adhesion to the resin matrix. Such a hydrophobization treatment will improve the adhesion of fillers to the resin and will improve the heat resistance and moisture absorption resistance of the resulting boards for flexible printed wiring.

The amount in which the flame retardant is added may be adjusted according to the effect which the flame retardant filler has in improving flame retardance. In some embodiments, when using fillers such as melamine polyphosphates or aluminum phosphine that are highly effective in increasing flame retardance, the amount is in a range between (and optionally including) any two of the following: 20, 21, 22, 23, 24, 25, 26, 27, 28, 29, 30, 31, 32, 33, 34, 35, 36, 37, 38, 39 and 40 wt % based on the total amount of the adhesive composition minus any solvent. In some embodiments, when using a filler such as aluminum hydroxide that has a high specific gravity, the amount is in a range between (and optionally including) any two of the following: 40, 41, 42, 43, 44, 45, 46, 47, 48, 49, 50, 51, 52, 53, 54, 55, 56, 57, 58, 59, 60, 61, 62, 63, 64, 65, 66, 67, 68, 69 and 70 wt % based on the total amount of the adhesive composition minus any solvent. When two or more kinds of filler having different effects in increasing flame retardance are used in combination, the amount added may be determined according to the performance of the fillers.

(5) Other Components

In some embodiments, pigments, leveling agents, defoamers, ion-trapping agents, silane coupling agents, mixtures thereof and the like may also be added in addition to the above ingredients to the adhesive composition. Silane coupling agents are selected from a group consisting of γ-glycidoxypropyl trimethoxysilane, γ-mercaptopropyl trimethoxysilane, γ-aminopropyl triethoxysilane, γ-ureidoporpyl triethoxysilane, N-β-aminoethyl-γ-aminopropyl trimethoxysilane and mixtures thereof.

The components of the adhesive composition are usually dissolved in solvent allowing the composition to be applied. In some embodiments, solvents are selected from a group consisting of methyl ethyl ketone, methyl isobutyl ketone, dioxane, ethanol, methyl cellosolve, ethyl cellosolve, propylene glycol monomethyl ether, propylene glycol monoethyl ether, N-methyl pyrrolidone, N,N-dimethyl formamide, toluene, and xylene. These may be used alone or in combination in any proportion as befits the intended application. In some embodiments, Methyl ethyl ketone, propylene glycol monomethyl ether, N,N-dimethyl formamide, toluene, and xylene are preferred from the standpoint of solubility.

A second aspect of the invention is an adhesive composition comprising (1) a elastomer component and (2) a resole phenolic resin, wherein the (2) resole phenolic resin in an amount in a range between (and optionally including) any two of the following: 7.5, 10, 15, 20, 25, 30, 35, 40, 45 and 48 wt % based on the total amount of the adhesive composition minus any solvent. In other words, the second aspect of the invention relates to an adhesive composition with a higher resole phenolic resin content than in conventional adhesive compositions. It became evident that this tends to increase the flame retardance of the adhesive composition. Particularly when flame retardant fillers are used, the flame retardance can be significantly increased with low amounts of flame retardant filler.

(1) Elastomer Component

In the present invention, the elastomer component is added to provide flexibility. The elastomer component also usually contributes to better adhesion. The elastomer component refers to components having elasticity produced by molecular chain entanglement. Depending on the temperature, polymers are in the form of solids (<T_{g}), glass (T_{g}<<Tₘ), or liquids (Tₘ<). Elastomer components are glassy at room temperature (25° C.). Examples of elastomer components include acrylic polymers, butadiene elastomer, polyamides, and polyesters. Particularly desirable ones are acid component-containing ethylene/acrylic copolymers, acid component-containing acrylic elastomers, and acid component-containing butadiene elastomer. The inclusion of these as elastomer components will improve adhesiveness and flexibility.

In some embodiments, functional groups included as acid components include carboxyl groups, sulfate groups, phosphate groups, and phenolic hydroxyl groups. In some embodiments, carboxyl groups are preferred in terms of stability. The acid component may be introduced by acid treatment of the elastomer component terminals or by the combined use of acid component-containing compounds in the form of monomers.

In some embodiments, ethylene/acrylic copolymers are selected from a group consisting of ethylene-alkyl acrylate-glycidyl acrylate copolymers, ethylene-methacrylic acid copolymers, ethylene-ethyl methacrylate-acrylic acid copolymers, ethylene-acrylic acid-butyl acrylate copolymers, ethylene-methyl acrylate-maleic acid monoester copolymers, ethylene-methyl acrylate-acrylonitrile copolymers, ethylene-ethyl methacrylate-styrene copolymers and mixtures thereof. Commercially available products include Bond Fast™ 7M (Sumitomo Chemical), Elvaloy® 4051, Vamac® G, and Vamac® GLS (all by Mitsui Du Pont Polychemical).

Acrylic elastomers are polymers based on acrylic acid esters and/or methacrylic acid esters. They may be prepared by any of solution polymerization, emulsion polymerization, suspension polymerization, or bulk polymerization. The acrylic acid esters and/or methacrylic acid esters will endow the acrylic adhesive composition with flexibility. In some embodiments, acrylic acid esters are selected from a group consisting of methyl acrylate, ethyl acrylate, n-butyl acrylate, isobutyl acrylate, isopentyl acrylate, n-hexyl acrylate, isooctyl acrylate, 2-ethylhexyl acrylate, n-octyl acrylate, isononyl acrylate, n-decyl acrylate, isodecyl acrylate and mixtures thereof. In some embodiments, methacrylic acid esters are selected from a group consisting of methyl methacrylate, ethyl methacrylate, n-butyl methacrylate, isobutyl methacrylate, isopentyl methacrylate, n-hexyl methacrylate, isooctyl methacrylate, 2-ethylhexyl methacrylate, n-octyl methacrylate, isononyl methacrylate, n-decyl methacrylate, isodecyl methacrylate and mixtures thereof. In some embodiments, the acrylic elastomers may be used in mixtures of two or more.

Examples of butadiene elastomer include acrylonitrile-butadiene copolymer elastomer obtained by the copolymerization of acrylonitrile and butadiene. In these, the terminals may be carboxylated to introduce an acid component. The acid component may also be introduced by ternary copolymerization of a carboxyl group-containing polymerizable monomer such as acrylic acid along with the acrylonitrile and butadiene. Examples of butadiene elastomer include Nipol™ 1072 and Nipol™ 1072J (both by Nippon Zeon), Krynac™ X7.5 (Bayer), Hycar CTBN1300XB, CTBN1300X15, and CTBNX1300XB (all by BF Goodrich Chemical), and PHR-1H (by JSR). In some embodiments, the butadiene elastomer may be used in mixtures of two or more.

In some embodiments, the elastomer component is preferably blended in a range between (and optionally including) any two of the following: 12, 15, 20, 22, 25, 28, 30, 32, 35, 38, 40, 42, 45, 48, 50, 52, 55, 58 and 60 wt % based on the total amount of the adhesive composition minus any solvent.

In another embodiment, when the total amount of the elastomer component and resole phenolic resin is used as the basis, the elastomer is preferably blended in a range between (and optionally including) any two of the following: 40, 45, 50, 55, 60, 65, 70 and 75 wt %. This range will ensure good adhesive properties.

(2) Resole Phenolic Resin

In the present invention, the resole phenolic resin is blended to three dimensionally cross link the elastomer component and improve heat resistance. Resole phenolic resin is a resin having a three dimensional reticulated structure, and is generally synthesized using phenol and formaldehyde starting materials. The molecular weight, softening point, and OH equivalent of the resole phenolic resin are not particularly limited.

In some embodiments, resole phenolic resins include those prepared from starting materials selected from a group consisting of phenol, bisphenol A, p-t-butylphenol, octylphenol, p-cumylphenol and other such alkyl phenols, p-phenylphenol, and cresol.

Examples of commercially available resole phenolic resins include Nikanol® (Fudow Corp.), Shonol® (Showa High Polymer Co., Ltd.), Sumilite® Resin (Sumitomo Bakelite), Phenolite® (Danippon Ink), and BKS® Resin (Georgia-Pacific Resin).

In some embodiments, the resole phenolic resin may be in the form of either a solid or liquid. In some embodiments, liquids are preferred from the standpoint of cross linking density.

In the second aspect of the invention, the adhesive composition contains a relatively large amount of resole phenolic resin. In some embodiments, the resole phenolic resin is blended in a range between (and optionally including) any two of the following: 7.5, 10, 12, 15, 20, 22, 25, 30, 32, 35, 40, 42, 45 and 48 wt % based on the total amount of the adhesive composition minus any solvent.

In another embodiment, when the total amount of the elastomer component and resole phenolic resin is used as the basis, the resole phenolic resin is preferably blended in a range between (and optionally including) any two of the following: 25, 30, 35, 40, 45, 50, 55 and 60 wt %.

The adhesive composition related to the second aspect of the invention may also include inorganic filler, pigments, leveling agents, defoamers, ion-trapping agents, silane coupling agents, and the like as needed. The components of the adhesive composition are usually dissolved in solvent allowing the composition to be applied. As these have been described in the first aspect of the invention, they will not be further elaborated here.

A method for forming a cover layer film using a liquid adhesive composition will be described below.

The adhesive composition of the invention is applied to release paper or polyimide film, and is dried, giving an adhesive composition in the form of a sheet. The coating method is not particularly limited. Examples include comma coaters and reverse roll coaters. The drying conditions are not particularly limited, although the residual solvent after drying is preferably no more than 1%. More than 1% may cause the residual solvent to foam during FPC pressing, resulting in bulges. The drying conditions preferably involve rapid heating and drying at temperature in a range between (and optionally including) any two of the following: 60, 65, 70, 75, 80, 85, 90, 95, 100, 105, 110, 115, 120, 125, 130, 135 and 140° C., depending on the solvent that has been used.

The dry adhesive film thickness may vary as needed. In some embodiments, the dry adhesive film thickness is in a range between (and optionally including) any two of the following: 5, 10, 20, 30, 40, 50, 60, 70, 80, 90, 100, 110, 120, 130, 140, 150, 160, 170, 180, 190 and 200 microns. An adhesive film less than 5 microns will result in less reliable interlayer insulation. A film thicker than 200 microns may not dry enough, leaving a greater amount of residual solvent, which may cause bulging during pressing in the manufacture of the FPC.

When an adhesive composition in the form of a sheet is formed on polyimide film, release paper is applied on the other side as needed. When an adhesive composition in the form of a sheet is formed on release paper, polyimide film may be applied on the other side as needed. Cover lay films generally have, but are not limited to, a three-layered structure comprising polyimide film, adhesive sheet, and release paper, and they may have other structures.

Examples of release paper that may be used in the invention include, but are not limited to, that in which a sealer of clay, polyethylene, polypropylene or the like is provided on both sides of paper such as wood-free paper, kraft paper, roll paper, or glassine paper, and a silicone-, fluorine-, or alkyd-based release agent is then applied on the applied layers; various olefin films alone such as polyethylene, polypropylene, ethylene-α-olefin copolymers, or propylene-α-olefin copolymers, and films such as polyethylene terephthalate on which the above release agents have been applied.

### EXAMPLES

The following materials were used in the examples.

(Elastomer Component)
Elastomer component A: ethylene acrylic elastomer Vamac® MR (E. I. du Pont de Nemours and Company)
Elastomer component B: acrylic resin (butyl acetate:acrylonitrile:methacrylic acid=55:40:5)
Elastomer component C: acrylic resin (butyl acetate:acrylonitrile:methacrylic acid=85:5:10)
Elastomer component D: modified acrylic butadiene elastomer Nipol 1072J (Nippon Zeon)

(Resole Phenolic Resin)
Resole phenolic resin A: PR-1440M (Fudow)
Resole phenolic resin B: GRL (Fudow)
Resole phenolic resin C: BLS-722 (Showa High Polymer)
Resole phenolic resin D: BKS-2710C (Showa High Polymer)
Resole phenolic resin E: CKM-912 (Showa High Polymer)
Resole phenolic resin F: CKM-983 (Showa High Polymer)
Resole phenolic resin G: BRE-174 (Showa High Polymer)
Resole phenolic resin H: CRM0803 (Showa High Polymer)
Resole phenolic resin I: BKS-355 (Showa High Polymer)
Resole phenolic resin J: BKS-2750 (Showa High Polymer)
Resole phenolic resin K: CKM-1282 (Showa High Polymer)
Resole phenolic resin L: CKM-1634 (Showa High Polymer)
Resole phenolic resin M: BRS-324 (Showa High Polymer)
Resole phenolic resin N: BLS-3122 (Showa High Polymer)
Resole phenolic resin O: PR-175 (Sumitomo Bakelite)
Resole phenolic resin P: PR-23 (Sumitomo Bakelite)
Resole phenolic resin Q: PR-50232 (Sumitomo Bakelite)
Resole phenolic resin R: PR-14170 (Sumitomo Bakelite)
Resole phenolic resin S: TD-773 (Dainippon Ink)
Resole phenolic resin T: TD-2615 (Dainippon Ink)
Resole phenolic resin U: TD-2266 (Dainippon Ink)
Resole phenolic resin V: J-325 (Dainippon Ink)
Resole phenolic resin W: GP-2600 (Georgia-Pacific Chem.)
Resole phenolic resin X: GP-2900 (Georgia-Pacific Chem.)
Resole phenolic resin Y: GP-2901 (Georgia-Pacific Chem.)

(Flame Retardant Aromatic Resin)
Flame retardant aromatic resin A: novolac phenolic resin Y-50 (Fudow)
Flame retardant aromatic resin B: novolac phenolic resin Y-100 (Fudow)
Flame retardant aromatic resin C: novolac phenolic resin Y-1000 (Fudow)
Flame retardant aromatic resin D: novolac phenolic resin H (Fudow)
Flame retardant aromatic resin E: novolac phenolic resin HP-150 (Fudow)
Flame retardant aromatic resin F: novolac phenolic resin HP-120 (Fudow)
Flame retardant aromatic resin G: novolac phenolic resin HP-100 (Fudow)
Flame retardant aromatic resin H: novolac phenolic resin HP-210 (Fudow)
Flame retardant aromatic resin I: novolac phenolic resin P-100 (Fudow)
Flame retardant aromatic resin J: novolac phenolic resin CKM-1634 (Showa High Polymer)
Flame retardant aromatic resin K: novolac phenolic resin CKM-1636 (Showa High Polymer)
Flame retardant aromatic resin L: novolac phenolic resin CKM-1737 (Showa High Polymer)
Flame retardant aromatic resin M: novolac phenolic resin CKM-1282 (Showa High Polymer)
Flame retardant aromatic resin N: novolac phenolic resin CKM-908 (Showa High Polymer)
Flame retardant aromatic resin O: novolac phenolic resin CRM-0909 (Showa High Polymer)
Flame retardant aromatic resin P: novolac phenolic resin CKM-2400 (Showa High Polymer)
Flame retardant aromatic resin Q: novolac phenolic resin CKM-2620 (Showa High Polymer)
Flame retardant aromatic resin R: novolac phenolic resin PR-12686R (Sumitomo Bakelite)
Flame retardant aromatic resin S: novolac phenolic resin PR-13349 (Sumitomo Bakelite)
Flame retardant aromatic resin T: novolac phenolic resin PR-50235A (Sumitomo Bakelite)
Flame retardant aromatic resin U: novolac phenolic resin PR-1 9900 (Sumitomo Bakelite)
Flame retardant aromatic resin V: novolac phenolic resin TD-2645 (Dainippon Ink)
Flame retardant aromatic resin W: novolac phenolic resin TD-1090 (Dainippon Ink)
Flame retardant aromatic resin X: novolac phenolic resin TD-2640 (Dainippon Ink)
Flame retardant aromatic resin Y: novolac phenolic resin TD-3130 (Dainippon Ink)

All of the above flame retardant aromatic resins pass the Flammability test. For example, Resole phenolic resin A, Resole phenolic resin F, Resole phenolic resin O, Resole phenolic resin V, Resole phenolic resin W on the polyimide film does not burn up to the other edge when it is burned on this flammability test.

(Flame Retardant Filler)
Flame retardant filler A: melamine polyphosphate PHOSMEL-100 (Nissan Kagaku Kogyo) phosphorus atom-based content=15 wt %
Flame retardant filler B: melamine polyphosphate PHOSMEL-200 (Nissan Kagaku Kogyo) phosphorus atom-based content=12 wt %
Flame retardant filler C: aluminum phosphonate OP935 (Clariant) phosphorus atom-based content=23 wt %
Flame retardant filler D: aluminum phosphonate OP930 (Clariant) phosphorus atom-based content=23 wt %
Flame retardant filler E: melamine polyphosphate Melapure*200/70 (Ciba Specialty Chemicals) phosphorus atom-based content=13 wt %
Flame retardant filler F: aluminum hydroxide BF013S (Nippon Light Metal) phosphorus atom-based content=0 wt %

(Solvent)
Methyl ethyl ketone

### Example 1

Based on the total amount of the adhesive composition minus any solvent, 35 g Vamac® MR (E. I. du Pont de Nemours and Company) as the resin component, 17 g PR-1440M (Fudow) as the resole phenolic resin, 19 g Y-50 (Fudow) as the as the flame retardant aromatic resin, 30 g PHOSMEL-100 (Nissan Kagaku Kogyou) as the flame retardant filler, and 100 g methyl ethyl ketone as solvent were introduced en masse into a 500 mL glass separable flask. The contents were vigorously stirred for 12 hours at room temperature. After having been stirred, the contents were filtered at ambient pressure, giving an adhesive composition. The resulting adhesive composition was evaluated in the following manner.

Flame retardance: based on UL Standard 94 (VTM-0 evaluated as OK).

Adhesive properties: 900 peel strength (copper foil) was measured based on JIS C6481.

Adhesive properties after edging: The same test piece used to evaluate adhesion was treated for 24 hours in an oven at 85° C. and 85 RH %, and the properties were determined in the same manner as in the evaluation of the adhesive properties above.

### Examples 2 through 34, and Comparative Examples 1 through 5

Adhesive resin compositions were prepared and evaluated in the same manner as in Example 1 except for the use of the components and amounts in Tables 1 and 2.

As shown in Tables 1 and 2, VTM-0 which is the benchmark for flame retardance could not be met with 65 wt % elastomer component, 5 wt % resole phenolic resin, and 30 wt % flame retardant filler (Comparative Examples 1, 2, 3, and 5). When 55 wt % elastomer component, 5 wt % resole phenolic resin, and 40 wt % highly flame retardant filler were mixed in an effort to improve the flame retardance, the flame retardance passed, but the adhesion was low (Comparative Example 4). In contrast, the adhesive compositions of the invention had better flame retardance and adhesion yet were halogen-free.

TABLE 1

| | Ex. 1 | 2 | 3 | 4 | 5 | 6 | 7 | 8 | 9 | 10 |
|---|---|---|---|---|---|---|---|---|---|---|
| Elastomer component A | 35 | | | | | 30 | 30 | 30 | 40 | 40 |
| Elastomer component B | | | | | | | | | | |
| Elastomer component C | | 35 | 35 | 35 | 35 | | | | | |
| Flame retardant aromatic resin A | 19 | | | | | | | | | |
| Flame retardant aromatic resin B | | 19 | | | | | | | | |
| Flame retardant aromatic resin C | | | 19 | | | | | | | |
| Flame retardant aromatic resin D | | | | 19 | | | | | | |
| Flame retardant aromatic resin E | | | | | | | | | | 20 |
| Flame retardant aromatic resin F | | | | | 19 | | | 20 | | |
| Flame retardant aromatic resin G | | | | | | | | | 20 | |
| Flame retardant aromatic resin H | | | | | | | 20 | | | |
| Flame retardant aromatic resin I | | | | | | 20 | | | | |
| Flame retardant aromatic resin J | | | | | | | | | | |
| Flame retardant aromatic resin K | | | | | | | | | | |
| Flame retardant aromatic resin L | | | | | | | | | | |
| Flame retardant aromatic resin M | | | | | | | | | | |
| Flame retardant aromatic resin O | | | | | | | | | | |
| Flame retardant aromatic resin P | | | | | | | | | | |
| Flame retardant aromatic resin U | | | | | | | | | | |
| Flame retardant aromatic resin V | | | | | | | | | | |
| Resole phenolic resin A | 17 | | | | | | | | | |
| Resole phenolic resin B | | 17 | | | | | | | | |
| Resole phenolic resin C | | | 17 | | | | | | | |
| Resole phenolic resin D | | | | | | | | | | |
| Resole phenolic resin E | | | | | | | | | | |
| Resole phenolic resin F | | | | | | | | | | |
| Resole phenolic resin G | | | | 17 | | | | | | |
| Resole phenolic resin H | | | | | | | | | | |
| Resole phenolic resin J | | | | | 17 | | | | | |
| Resole phenolic resin K | | | | | | | | | 20 | |
| Resole phenolic resin L | | | | | | | | | | |
| Resole phenolic resin M | | | | | | | 20 | | | 20 |
| Resole phenolic resin N | | | | | | | | | | |
| Resole phenolic resin P | | | | | | 20 | | | | |
| Resole phenolic resin R | | | | | | | | 20 | | |
| Resole phenolic resin S | | | | | | | | | | |
| Resole phenolic resin T | | | | | | | | | | |
| Flame retardant filler A | 30 | | | | 30 | | 30 | | | |
| Flame retardant filler B | | | | | | 30 | | | | |
| Flame retardant filler C | | | | 15 | | | | | 20 | |
| Flame retardant filler D | | | | | | | | | | 20 |
| Flame retardant filler E | | 30 | 30 | | | | | 30 | | |
| Flame retardant filler F | | | | 15 | | | | | | |
| Solvent | 100 | 100 | 100 | 100 | 100 | 100 | 100 | 100 | 100 | 100 |
| VTM-0 | ◯ | ◯ | ◯ | ◯ | ◯ | ◯ | ◯ | ◯ | ◯ | ◯ |
| Adhesive properties | 0.5 | 0.5 | 0.5 | 0.4 | 0.5 | 0.6 | 0.6 | 0.6 | 0.4 | 0.4 |
| Adhesive properties after edging | 0.5 | 0.5 | 0.5 | 0.4 | 0.5 | 0.6 | 0.6 | 0.6 | 0.4 | 0.4 |
| | 11 | 12 | 13 | 14 | 15 | 16 | 17 | 18 | 19 | 20 |
| Elastomer component A | 40 | 35 | | | | | 35 | 35 | | |
| Elastomer component B | | | | | | | | | 35 | 35 |
| Elastomer component C | | | 35 | 35 | 35 | 35 | | | | |
| Flame retardant aromatic resin A | | | | | | | | | | |
| Flame retardant aromatic resin B | | | | | | | | | | |
| Flame retardant aromatic resin C | | | | | | | | | | |
| Flame retardant aromatic resin D | | 19 | | | | | | | | |
| Flame retardant aromatic resin E | | | | | | | | | | |
| Flame retardant aromatic resin F | | | | | | | | | | |
| Flame retardant aromatic resin G | | | | | | | | | | |
| Flame retardant aromatic resin H | 20 | | | | | | | | | |
| Flame retardant aromatic resin I | | | | | | | | | | |
| Flame retardant aromatic resin J | | | 20 | | | | | | | |
| Flame retardant aromatic resin K | | | | 20 | | | | | | |
| Flame retardant aromatic resin L | | | | | 20 | | | | | |
| Flame retardant aromatic resin M | | | | | | 20 | | | | |
| Flame retardant aromatic resin O | | | | | | | | 19 | | |
| Flame retardant aromatic resin P | | | | | | | 19 | | | |
| Flame retardant aromatic resin U | | | | | | | | | 20 | |
| Flame retardant aromatic resin V | | | | | | | | | | 20 |
| Resole phenolic resin A | | | | | | | | | | |
| Resole phenolic resin B | | | | | | | | | | |
| Resole phenolic resin C | | | | | | | | | | |
| Resole phenolic resin D | | | 15 | | | | | | | |
| Resole phenolic resin E | | | | 15 | | | | | | |
| Resole phenolic resin F | | 17 | | | | | | | | |
| Resole phenolic resin G | | | | | 15 | | | | | |
| Resole phenolic resin H | | | | | | 15 | | | | |
| Resole phenolic resin J | | | | | | | | | | |
| Resole phenolic resin K | | | | | | | | | | |
| Resole phenolic resin L | 20 | | | | | | | | | |
| Resole phenolic resin M | | | | | | | | | | |
| Resole phenolic resin N | | | | | | | | 17 | | |
| Resole phenolic resin P | | | | | | | | | | |
| Resole phenolic resin R | | | | | | | | | 15 | |
| Resole phenolic resin S | | | | | | | | | | 15 |
| Resole phenolic resin T | | | | | | | 17 | | | |
| Flame retardant filler A | | | 30 | | | | | | | |
| Flame retardant filler B | | | | 30 | 30 | 30 | 30 | | | |
| Flame retardant filler C | 20 | 15 | | | | | | 15 | | |
| Flame retardant filler D | | | | | | | | | | |
| Flame retardant filler E | | | | | | | | | 30 | 30 |
| Flame retardant filler F | | 15 | | | | | | 15 | | |
| Solvent | 100 | 100 | 100 | 100 | 100 | 100 | 100 | 100 | 100 | 100 |
| VTM-0 | ◯ | ◯ | ◯ | ◯ | ◯ | ◯ | ◯ | ◯ | ◯ | ◯ |
| Adhesive properties | 0.4 | 0.4 | 0.5 | 0.5 | 0.5 | 0.6 | 0.5 | 0.4 | 0.5 | 0.5 |
| Adhesive properties after edging | 0.4 | 0.4 | 0.5 | 0.5 | 0.5 | 0.5 | 0.5 | 0.4 | 0.5 | 0.5 |

TABLE 2

| | Ex. 21 | 22 | 23 | 24 | 25 | 26 | 27 | 28 | 29 | 30 |
|---|---|---|---|---|---|---|---|---|---|---|
| Elastomer component A | | | | | | | | | | |
| Elastomer component B | 35 | 35 | 35 | 35 | 35 | 35 | 35 | 35 | 35 | |
| Elastomer component C | | | | | | | | | | 35 |
| Elastomer component D | | | | | | | | | | |
| Flame retardant aromatic resin N | | | | 20 | | | 20 | | | |
| Flame retardant aromatic resin O | | | | | 20 | | | | | |
| Flame retardant aromatic resin Q | | | | | | 15 | | | | |
| Flame retardant aromatic resin R | | | | | | | | | | 20 |
| Flame retardant aromatic resin S | | | | | | | | | | |
| Flame retardant aromatic resin T | | | | | | | | | | |
| Flame retardant aromatic resin V | | | | | | | | 20 | | |
| Flame retardant aromatic resin W | 20 | | | | | | | | 20 | |
| Flame retardant aromatic resin X | | 20 | | | | | | | | |
| Flame retardant aromatic resin Y | | | 15 | | | | | | | |
| Resole phenolic resin I | | | | | 15 | | | | | |
| Resole phenolic resin M | | | | | | 20 | | | | |
| Resole phenolic resin N | | | | 15 | | | | | | |
| Resole phenolic resin O | | | | | | | | | | 15 |
| Resole phenolic resin P | | | | | | | | | | |
| Resole phenolic resin Q | | | | | | | | | | |
| Resole phenolic resin T | | | 20 | | | | | | | |
| Resole phenolic resin U | | 15 | | | | | | | | |
| Resole phenolic resin V | 15 | | | | | | | | | |
| Resole phenolic resin W | | | | | | | 15 | | | |
| Resole phenolic resin X | | | | | | | | 15 | | |
| Resole phenolic resin Y | | | | | | | | | 15 | |
| Flame retardant filler A | 30 | 30 | | | | | | | | |
| Flame retardant filler B | | | | | | | | | | 30 |
| Flame retardant filler C | | | 15 | 15 | 15 | 15 | 15 | 15 | 15 | |
| Flame retardant filler D | | | | | | | | | | |
| Flame retardant filler E | | | | | | | | | | |
| Flame retardant filler F | | | 15 | 15 | 15 | 15 | 15 | 15 | 15 | |
| Solvent | 100 | 100 | 100 | 100 | 100 | 100 | 100 | 100 | 100 | 100 |
| VTM-0 | ◯ | ◯ | ◯ | ◯ | ◯ | ◯ | ◯ | ◯ | ◯ | ◯ |
| Adhesive properties | 0.5 | 0.5 | 0.4 | 0.4 | 0.4 | 0.4 | 0.4 | 0.4 | 0.4 | 0.4 |
| Adhesive properties after aging | 0.5 | 0.5 | 0.4 | 0.4 | 0.4 | 0.4 | 0.4 | 0.4 | 0.4 | 0.4 |

| | | | | | Comp. | | | | |
|---|---|---|---|---|---|---|---|---|---|
| | 31 | 32 | 33 | 34 | Ex. 1 | 2 | 3 | 4 | 5 |
| Elastomer component A | | | | 35 | 65 | | | 55 | |
| Elastomer component B | | | | | | 65 | | | |
| Elastomer component C | 35 | 35 | | | | | 65 | | |
| Elastomer component D | | | 35 | | | | | | 65 |
| Flame retardant aromatic resin N | | | 20 | | | | | | |
| Flame retardant aromatic resin O | | | | | | | | | |
| Flame retardant aromatic resin Q | | | | | | | | | |
| Flame retardant aromatic resin R | | | | | | | | | |
| Flame retardant aromatic resin S | 20 | | | | | | | | |
| Flame retardant aromatic resin T | | 20 | | | | | | | |
| Flame retardant aromatic resin V | | | | | | | | | |
| Flame retardant aromatic resin W | | | | | | | | | |
| Flame retardant aromatic resin X | | | | | | | | | |
| Flame retardant aromatic resin Y | | | | | | | | | |
| Resole phenolic resin I | | | 15 | | | | | | |
| Resole phenolic resin M | | | | | | | | | |
| Resole phenolic resin N | | | | | | | | | |
| Resole phenolic resin O | | | | 35 | | | | | |
| Resole phenolic resin P | 15 | | | | | | | | |
| Resole phenolic resin Q | | 15 | | | | | | | |
| Resole phenolic resin T | | | | | | | | | |
| Resole phenolic resin U | | | | | | | | | 5 |
| Resole phenolic resin V | | | | | 5 | | | | |
| Resole phenolic resin W | | | | | | 5 | | | |
| Resole phenolic resin X | | | | | | | 5 | | |
| Resole phenolic resin Y | | | | | | | | 5 | |
| Flame retardant filler A | 30 | 30 | 30 | 30 | | | 30 | | 30 |
| Flame retardant filler B | | | | | | | | | |
| Flame retardant filler C | | | | | | | | | |
| Flame retardant filler D | | | | | | | | 40 | |
| Flame retardant filler E | | | | | 30 | 30 | | | |
| Flame retardant filler F | | | | | | | | | |
| Solvent | 100 | 100 | 100 | 100 | 100 | 100 | 100 | 100 | 100 |
| VTM-0 | ◯ | ◯ | ◯ | ◯ | X | X | X | ◯ | X |
| Adhesive properties | 0.6 | 0.5 | 0.4 | 0.7 | 0.5 | 0.4 | 0.7 | 0.1 | 0.2 |
| Adhesive properties after aging | 0.6 | 0.5 | 0.4 | 0.7 | 0.5 | 0.4 | 0.3 | 0 | 0.2 |

What is claimed is:

1. An adhesive composition, comprising:
A. 12-48 weight parts of an elastomer component;
B. 2-55 weight parts of a resole phenolic resin; and
C. 20-70 weight parts of a flame retardant aromatic resin.

2. An adhesive composition according to claim 1, further comprising 20-70 weight parts of a flame retardant filler.

3. An adhesive composition according to claim 1, wherein the elastomer component is a synthetic resin selected from a group consisting of acrylic based elastomers, butadiene based elastomers and mixtures thereof.

4. An adhesive composition according to claim 1, wherein the flame retardant aromatic resin is selected from a group consisting of novolac phenolic resins, xylene-modified phenolic resins and mixtures thereof.

5. An adhesive composition according to claim 2, wherein the flame retardant filler is selected from a group consisting of melamine polyphosphate based flame retardant fillers, aluminum phosphonate phosphorus-based flame retardant fillers wherein the phosphorus content is at least 3 weight percent based upon the total amount of the adhesive composition excluding solvent, and mixtures thereof.

6. An adhesive composition according to claim 1, wherein the adhesive is in a form of a sheet.

7. An adhesive composition comprising:
A. an elastomer component; and
B. a resole phenolic resin in an amount of 7.5 to 48 wt % based on the total amount of the adhesive composition excluding any solvent.

8. An adhesive composition according to claim 7, further comprising a flame retardant filler.

9. An adhesive composition according to claim 7, wherein the elastomer component is a synthetic resin selected from a group consisting of ethylene/acrylic copolymers, acrylic elastomers, butadiene based elastomers and mixtures thereof.

10. An adhesive composition according to claim 7, further comprising a flame retardant aromatic resin selected from a group consisting of novolac phenolic resins, xylene-modified phenolic resins and mixtures thereof.

11. An adhesive composition according to claim 8, wherein the flame retardant filler is selected from a group consisting of a melamine polyphosphate derivative, an aluminum phosphonate phosphorus-based flame retardant filler wherein the phosphorus atom-based content is at least 3 wt % based on the total amount of the adhesive composition excluding any solvent, and mixtures thereof.

12. An adhesive composition according to claim 6 wherein the adhesive is in a form of a sheet and the sheet is laminated on to a flame retardant insulating film to form a cover lay film.
